(19) United States
(12) Patent Application Publication
(10) Pub. No.: US 2007/0102917 A1
(43) Pub. Date: May 10, 2007

(54) QuickFlap

(76) Inventor: Vernon R. Hopkins JR., Worcester, MA (US)

Correspondence Address: Wilson Daniel Swayze, Jr, 3804 Clearwater Ct., Plano, TX, 75025, US

(21) Appl. No.: 11/268,124

(22) Filed: Nov. 7, 2005

(51) Int. Cl. B62D 25/18

(52) U.S. Cl. 280/854

(57) ABSTRACT

An apparatus for deflecting tire spray includes a flap for deflecting the tire spray, a deformable holding article to hold the flap and a bracket to accept the deformable holding article.

### FIELD OF THE INVENTION

The present invention relates to flaps for vehicles, and more particularly to flaps for vehicles and trailers that can be easily removed and replaced.

### BACKGROUND

It is well-known that trucks, particularly trucks that will haul large amounts of material, have large wheels. These large wheels tend to pick up water and debris when it is raining and tend to throw this water and debris for large distances especially when the truck is traveling at a high rate of speed. This may cause problems for other vehicles especially smaller cars that are sharing the highway with these trucks. The water and debris reach the windshields of these other vehicles, resulting in an obstructed view for the driver. An obvious solution to this problem is to require a flap to be installed behind the wheels of the trucks and trailers to extend the full width of the tire and to extend substantially the full height of the tire. This solution works sufficiently well such that most states now require the trucks to have flaps. However, one problem is that the flaps will eventually wear out and break off, requiring the replacement of the broken flap. In many cases, this procedure takes a significantly large amount of time and cost due to the fusion of the mounting hardware associated with a flap.

### SUMMARY

The present invention provides a flap, which may be used for vehicles such as a car, truck or trailer, and the flap is placed behind the wheels of the vehicle so as to form a yieldable surface or baffle to which tire spray is directed and received.

In addition, the present invention provides a flap which is quickly and easily removed and replaced and which may be locked in position on the vehicle and readily unlocked for removal or replacement.

The present invention provides brackets that can be easily attached to the vehicle body and that includes a slot for receiving the flap.

The present invention allows the flap of the vehicle to be replaced without special tools, quickly and easily. Consequently, the flap of the vehicle if badly damaged or worn can be easily replaced by the vehicle driver instead of the vehicle driver waiting until the flap could be serviced by a professional.

The present invention includes a deformable holding adapter for holding the flap. The deformable holding adapter is formed to be positioned inside the bracket with the flap positioned within the slot of the bracket.

The present invention includes a locking apparatus to lock the deformable holding adapter and the flap within the bracket. The locking apparatus does not require any special tools in order to remove or replace the flap within the bracket.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of the bracket of the present invention showing slot or opening for flap mount;

FIG. 2 illustrates a perspective view of the deformable holding article and flap;

FIG. 3 illustrates a partial perspective view of the alternate deformable holding article and a standard (adapter) flap;

FIGS. 4a-d illustrate a perspective view of the locking apparatus.

### DETAILED DESCRIPTION

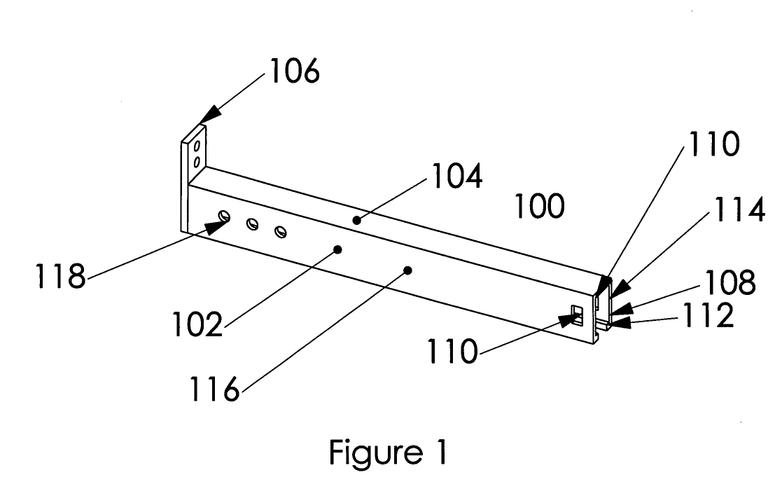

FIG. 1 illustrates a bracket 100 to hold a flap in accordance with the teachings of the present invention. The bracket 100 is positioned on the vehicle to be in back of a tire of the vehicle and at a height of approximately the top of the tire. FIG. 1 shows the bracket 100 as a hollow housing having sidewalls 102 and top 104 and one end of the bracket 100 is connected to a attachment plate 106 to attach the bracket 100 to the vehicle or trailer. The attachment plate 106 includes holes for mounting on the vehicle. The bottom 112 of the bracket 100 includes a slot 108 to accept the flap. The slot 108 may extend substantially along the entire length of the bracket 100 or some portion of the length and or may have a stopping pin 118 to allow a shorter flap to be positioned within the bracket 100. The bracket 100 may be formed from steel or other suitable material and may have a galvanized coating in order to avoid rust and other forms of corrosion. Additionally, the bracket 100 may be solid or laminated. The bracket 100 additionally includes a first opening 114 near one end of the bracket 100 to accept the deformable holding article and a second opening 110 positioned in each side of the side wall 102 to provide for a locking apparatus in order to secure the flap within the bracket 100. The bracket 100 may include an area 116 of reflective material, for example dots of red/white reflector.

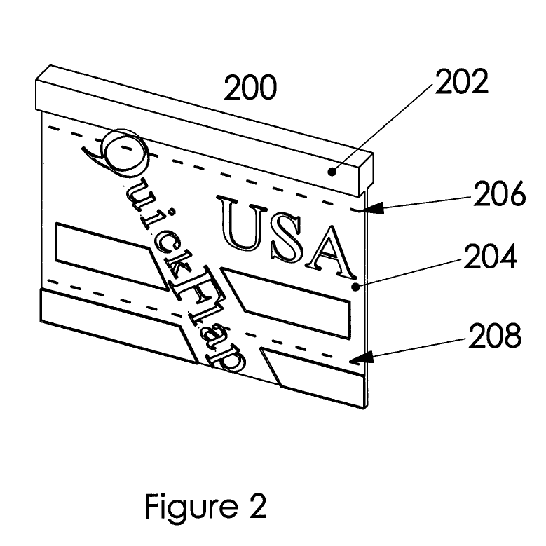

FIG. 2 illustrates a flap assembly 200 of the present invention. The flap assembly 200 includes a deformable holding adapter 202 or a molded one piece or built-up assembly to hold the flap. The deformable holding adapter 202 or a molded one piece or built-up assembly is form to fit into the opening in one end of the bracket 100 and has a length that is approximately the same length of the slot of the bracket 100 or shorter utilizing a stopping pin. The flap 204 may include weaken areas 206, 208 which may be present in any number and which are to adjust the length of the flap 204 to correspond approximately to the height of the tire. FIG. 2 shows the weaken area 206 near the top of the flap 204 and shows the weaken area 208 near the bottom of the flap 204, if the flap is caught on something, part of the flap will break free instead of loosing a complete flap. The position of these weaken areas could be anywhere along the longitudinal side of the flap 204. The weaken areas 206, 208 could be formed by slits or perforations in the flap 204.

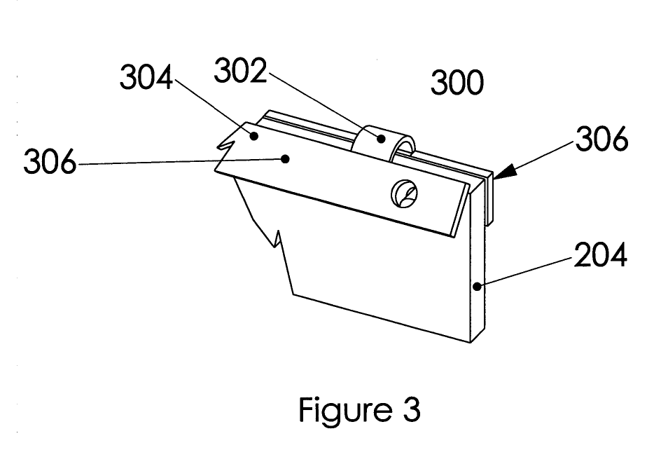

FIG. 3 illustrates a alternate mounting, the deformable holding adapter 300 to hold the flap 204 so that the bracket 100 will accept the deformable holding adapter 300. The deformable holding adapter 300 includes arms 306 forming the side of the deformable holding adapter 300 and which are connected to the top 302 of the deformable holding adapter 300. The deformable holding adapter 300 may be made from a material such as plastic or any other suitable material so that the arms 306 can be rotated as a result of the deformable characteristics of the plastic. The arms 306 on each side of the deformable holding adapter 300 rotate along the longitudinal axis so that a flap 204 can be held by the deformable holding adapter 300 and positioned within the bracket 100. Since the flaps 204 can have varying thickness, the rotation of the arms 306 accommodates the varying thickness of the flap 204. Optionally, the arms 306 may include a handle 304 that can be easily grasped by a user. Pins 308 can go through the flap and may lock/snap in to the other side 310 to accommodate standard flaps.

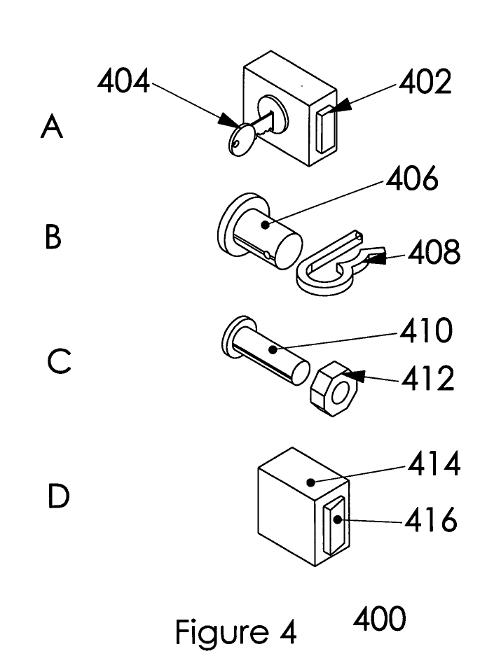

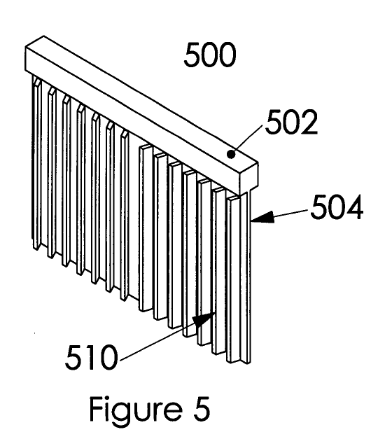

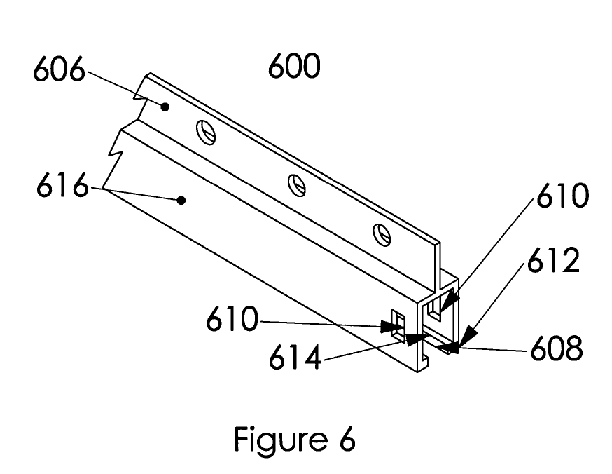

FIG. 4 illustrates four examples of the locking apparatus that can be used in cooperation with the bracket 100 in order to retain the deformable holding adapter 300 and the flap 204 on the bracket 100. These examples require no special tools to lock and unlock the flap 204 on the bracket 100 Other examples of the locking apparatus 400 are within the scope of the present invention.

FIG. 4a illustrates a locking apparatus which includes a key 404 and plunger 402 such that when the key 404 is turned the plunger 402 is either extended or retracted from the opening 110 of the bracket 100. FIG. 4b illustrates another locking apparatus 400 including a cotter 406 and pin 408. FIG. 4c illustrates another locking apparatus 400 including a bolt 410 and nut 412. FIG. 4d illustrates another locking apparatus 400 having a snap-in lock including deformable arms 414 and having an extending element 416. The deformable arms 414 keep the extending element 416 in the opening 110 until the user deforms the deformable arms 414 closed for example with a screwdriver.

FIG. 5 additionally shows a rain guide 510, which may be added to guide the tire spray down the flap 504 towards the road surface and to deflect road debris back into the tire area.

FIG. 6 illustrates an alternate bracket 600 of the present invention. The bracket 600 includes an attachment plate 606 which is shown mounted along the longitudinal axis of the top 604 of the bracket 600. The attachment plate 606 may extend the substantial entire length of the top 604, or may only extend for a portion of the length of the top 604. The bracket 600 may include an area 616 of reflective material, for example dots of red/white reflector.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) An apparatus for deflecting tire spray and debris, comprising:
a flap for deflecting said tire spray and debris,
a deformable holding article to hold said flap,
a bracket to accept said deformable holding article.

2) An apparatus for deflecting tire spray and debris as in claim 1, wherein said bracket includes a slot or opening to accept said flap.

3) An apparatus for deflecting tire spray and debris as in claim 1, wherein said apparatus includes a locking apparatus to lock said flap.

4) An apparatus for deflecting tire spray and debris as in claim 3, wherein said bracket includes an opening for said locking apparatus.

5) An apparatus for deflecting tire spray and debris as in claim 1, wherein said deformable holding article includes an arm to hold said flap.

6) An apparatus for deflecting tire spray and debris as in claim 5, wherein said arm rotates to release said flap.

7) An apparatus for deflecting tire spray and debris as in claim 5, wherein said arm includes a handle.

8) An apparatus for deflecting tire spray and debris as in claim 3, wherein said locking apparatus includes a cotter pin.

9) An apparatus for deflecting tire spray and debris as in claim 3, wherein said locking apparatus includes a bolt and nut.

10) An apparatus for deflecting tire spray and debris as in claim 3, wherein said locking apparatus includes a snap-in lock with a deformable arm.

11) A method for forming an apparatus for deflecting tire spray and debris, comprising the steps of:
forming a flap for deflecting said tire spray and debris,
forming said flap with a deformable holding article to hold said flap,
forming a bracket to accept said deformable holding article.

12) A method for forming an apparatus for deflecting tire spray and debris as in claim 11, wherein said step of forming said bracket includes a step to forming a slot or opening to accept said flap.

13) A method for forming an apparatus for deflecting tire spray and debris as in claim 11, wherein said step of forming said apparatus includes the step of forming a locking apparatus to secure said flap.

14) A method for forming an apparatus for deflecting tire spray and debris as in claim 13, wherein said step of forming said bracket includes the step of forming an opening for said locking apparatus.

15) A method for forming an apparatus for deflecting tire spray and debris as in claim 11, wherein said deformable holding article includes an arm to hold said flap.

16) A method for forming an apparatus for deflecting tire spray and debris as in claim 15, wherein the method includes the step of rotating said arm to release said flap.

17) A method for forming an apparatus for deflecting tire spray and debris as in claim 15, wherein said arm includes a handle.

18) A method for forming an apparatus for deflecting tire spray and debris as in claim 13, wherein said locking apparatus includes a cotter pin.

19) A method for forming an apparatus for deflecting tire spray and debris as in claim 13, wherein said locking apparatus includes a bolt and nut.

20) An apparatus for deflecting tire spray and debris as in claim 1, wherein said flap includes a weaken area to break away if said flap is caught on an object.
